(19) United States
(12) Patent Application Publication
(10) Pub. No.: US 2018/0095937 A1
(43) Pub. Date: Apr. 5, 2018

(54) Automatic Data Processing System, Automatic Data Processing Method, and Automatic Data Analysis System

(71) Applicant: Hitachi, Ltd., Chiyoda-ku, Tokyo (JP)

(72) Inventors: Junichi HIRAYAMA, Tokyo (JP); Ryuji MINE, Tokyo (JP)

(21) Appl. No.: 15/566,523

(22) PCT Filed: Apr. 17, 2015
(86) PCT No.: PCT/JP2015/061778

§ 371 Date: Oct. 13, 2017

(51) Int. Cl. G06F 17/18; G06F 17/15; G06F 7/02; G06F 17/30

(52) U.S. Cl. CPC G06F 17/18; G06F 17/30985; G06F 7/02; G06F 17/15

(57) ABSTRACT

An automatic data processing system includes a reception section, a data type determination section, a measurement scale determination section, and a data processing section. The reception section receives data on numbers, characters, and symbols. The data type determination section determines the type of the data. The measurement scale determination section determines the measurement scale of the data in accordance with the distribution of the data when the data is of a numeric type. The data processing section processes the data in accordance with the determined measurement scale.

### TECHNICAL FIELD

The present invention relates to an automatic data processing system, an automatic data processing method, and an automatic data analysis system.

### BACKGROUND ART

In recent years, systems for analyzing a large amount of data called “big data” and assisting decision making, which was previously conducted based on human intuition and experience, are increasingly developed at a rapid pace. For example, a certain data analysis method employed by a recently developed system mainly provides correlation analysis for determining an explanatory variable that varies a certain objective variable, regression analysis for predicting the value of an objective variable from the values of explanatory variables, and machine learning and statistical analysis such as clustering for grouping variables having similar tendencies.

In most cases, stored raw data is not suitable for data analysis. Therefore, data for analysis is often prepared by performing a processing operation on raw data. A data processing operation may be accomplished, for example, by performing a quantization or determining a representative value. The quantization is performed, for example, by classifying data distributed in the range of 0.0 to 30.0 into Low (0.0 to 10.0), Middle (10.0 to 20.0), and High (20.0 to 30.0) zones and newly labeling values belonging to the individual zones. The representative value is a numeric value that is representative of data in a certain column and obtained, for example, by determining the average and the frequencies of individual values of the data. An example of data processing will now be described with reference to FIG. 1. FIG. 1 shows a case where data stored in an input table 100 in an RDB (relational database) format is compressed in an output table 110. While the input table 100 uses “Work ID” (104) as the key, the output table 110, which shows the compressed data, uses “Worker ID” (111) as the key. In this instance, records having the same “Worker ID” (101) are grouped, and the representative value of each group is determined. As processing is performed in this manner, the values in each column can be corrected to values representative of workers “700A”, “700B”, and “700C”. Patent Literature (PTL) 1 relates to the above-described data processing. According to this patent literature, new variables are created based on variables stored in a table in accordance with a predetermined rule and calculation method, and then added as new explanatory variables. As an example of a rule and calculation method, an aggregation operation method may be used to average any time-series variables at one-hour intervals. After the explanatory variables are added in the above manner, an explanatory variable contributing to an objective variable is identified by calculating the degrees of contribution of objective variables and explanatory variables.

Further, a measurement scale is known as an index for setting the properties of data. For example, according to Patent Literature (PTL) 2, a dispersion calculation formula is changed in accordance with the measurement scale of data to calculate a dispersion, determine the uniqueness of products and services of a company from the calculated dispersion, and create a positioning map. Moreover, Non-Patent Literature (NPL) 1 contains the description of measurement scales.

### CITATION LIST

### Patent Literature

PTL 1: Japanese Patent Application Laid-Open No. 2102-27880

PTL 2: Japanese Patent Application Laid-Open No. 2011-243050

### NON-PATENT LITERATURE

NPL 1: S. S. Stevens, “On the Theory of Scales of Measurement,” Science, Vol. 103, No. 2684, pp. 677-680, June 1946

### SUMMARY OF INVENTION

### Technical Problem

However, as regards processing operations on data, data indicative of apparently the same numeric value have different properties and are applicable to different processing operations. For example, determining the representative value, such as an average value, of data indicative of quantity, such as the time required for each work item (180 s, 240 s, . . . ) is meaningful. However, determining the average value of data indicative of signs or names, such as worker IDs (23513, 24512, . . . ), is meaningless. When such a meaningless operation is performed, proper analysis results are not obtained. More specifically, wrong analysis results may be obtained, or an analysis result to be truly extracted may be buried within meaningless analysis results.

An applicable data processing operation described in the foregoing example requires that a data analysis specialist perform preprocessing by manually set all columns in a proper manner. This results in an increase in the cost of analysis. Further, such setup cannot easily be performed by a non-specialist having no knowledge of data analysis.

Further, according to Patent Literature (PTL) 2, the method of dispersion calculation is changed in accordance with the measurement scale of data. However, this requires a user to designate the measurement scale of data in advance, and the measurement scale cannot automatically be determined.

The present invention has been made in view of the above circumstances. An object of the present invention is to provide a system and method for automatically determining the measurement scale, which is an index for determining the properties of data, and performing data processing by a method appropriate for each data. Another object of the present invention is to provide a data analysis system capable of automatically determining the measurement scale of data.

### Solution to Problem

In addressing the above problem, according to an aspect of the present invention, there is provided an automatic data processing system including a reception section, a data type determination section, a measurement scale determination section, and a data processing section. The reception section receives data on numbers, characters, and symbols. The data type determination section determines the type of the data. The measurement scale determination section determines the measurement scale of the data in accordance with the distribution of the data when the data is numeric. The data processing section processes the data in accordance with the measurement scale.

According to another aspect of the present invention, there is provided an automatic data processing method including a reception step, a data type determination step, a measurement scale determination step, and a data processing step. The reception step receives data. The data type determination step determines the type of the data. The measurement scale determination step determines the measurement scale of the data in accordance with the distribution of the data when the data is numeric. The data processing step processes the data in accordance with the measurement scale.

According to still another aspect of the present invention, there is provided a data analysis system including a reception section, a data type determination section, a measurement scale determination section, a data processing section, a data analysis section, and an output section. The reception section receives data on numbers, characters, and symbols. The data type determination section determines the type of the data. The measurement scale determination section determines the measurement scale of the data in accordance with the distribution of the data when the data is numeric. The data processing section processes the data in accordance with the measurement scale. The data analysis section analyzes the data processed by the data processing section. The output section outputs the data analyzed by the data analysis section.

### Advantageous Effects of Invention

The present invention provides a system and method for automatically determining the measurement scale, which is an index for determining the properties of data, and automatically processing the data. The present invention also provides a data analysis system capable of automatically determining the measurement scale of the data.

### BRIEF DESCRIPTION OF DRAWINGS

FIG. 1 is a diagram illustrating an example of data processing.

FIG. 2 is a diagram illustrating various measurement scales.

FIG. 3 is a diagram illustrating examples of input/output tables.

FIG. 4 is a flowchart illustrating a process performed by an automatic data processing system.

FIG. 5 is a flowchart illustrating a process performed in a data distribution determination step.

FIG. 6 is a flowchart illustrating a process performed in a regular expression determination step.

FIG. 7 is a flowchart illustrating a process performed in a processing operation determination section.

FIG. 8 is a diagram illustrating an example of a table indicative of applicable processing operations for each measurement scale.

FIG. 9 is a flowchart illustrating a process performed in a processing operation selection section.

FIG. 10 is a flowchart illustrating a process performed in an operation robustness determination step.

FIG. 11 is a diagram illustrating a hardware configuration of the automatic data processing system.

FIG. 12 is a set of diagrams illustrating the distributions of data having various measurement scales.

FIG. 13 is a set of diagrams illustrating the distributions of data exhibiting homoscedasticity and data exhibiting heteroscedasticity.

FIG. 14 is a set of diagrams illustrating the distributions of monotonously changing data.

FIG. 15 is a diagram illustrating the determination of homoscedasticity of data.

FIG. 16 is a diagram illustrating an example of GUI for data processing.

FIG. 17 is a diagram illustrating a configuration of an automatic data analysis system.

FIG. 18 is a diagram illustrating a configuration of the automatic data processing system.

FIG. 19 is a diagram illustrating a configuration of the automatic data processing system having a processing operation database and a processing operation determination section.

FIG. 20 is a diagram illustrating a configuration of the automatic data processing system having a processing operation selection section.

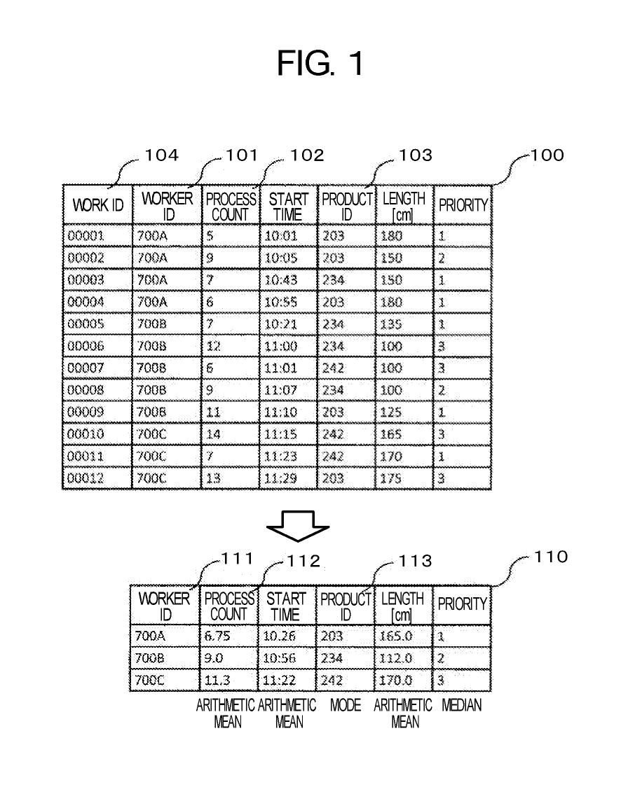

### DESCRIPTION OF EMBODIMENTS

In the following description of embodiments, if necessary for convenience sake, a description of the present invention will be divided into a plurality of sections or embodiments, but unless specifically stated, they are not unrelated to each other, but are in such a relation that one is, for example, a modification, a detailed explanation, or a supplementary explanation of a part or the whole of the other. Moreover, in the embodiments described below, when the number of elements (including the number of pieces, numeric values, amounts, ranges, etc.) is mentioned, the number of elements is not limited to a specific number unless specifically stated or apparently limited to a specific number in principle. The number larger or smaller than the specific number is also applicable.

Further, in the embodiments described below, it is obvious that the components (including element steps) are not always indispensable unless, for example, specifically stated or apparently indispensable in principle. Similarly, in the embodiments described below, when, for example, the shape of the components and the positional relationship therebetween are mentioned, for example, the substantially approximate or similar shapes are included therein unless they are specifically stated or can be apparently excluded in principle. The same goes for the aforementioned numeric values and ranges.

### First Embodiment

A first embodiment of the present invention will now be described with reference to an example of an automatic data processing system that automatically determines the measurement scale of data.

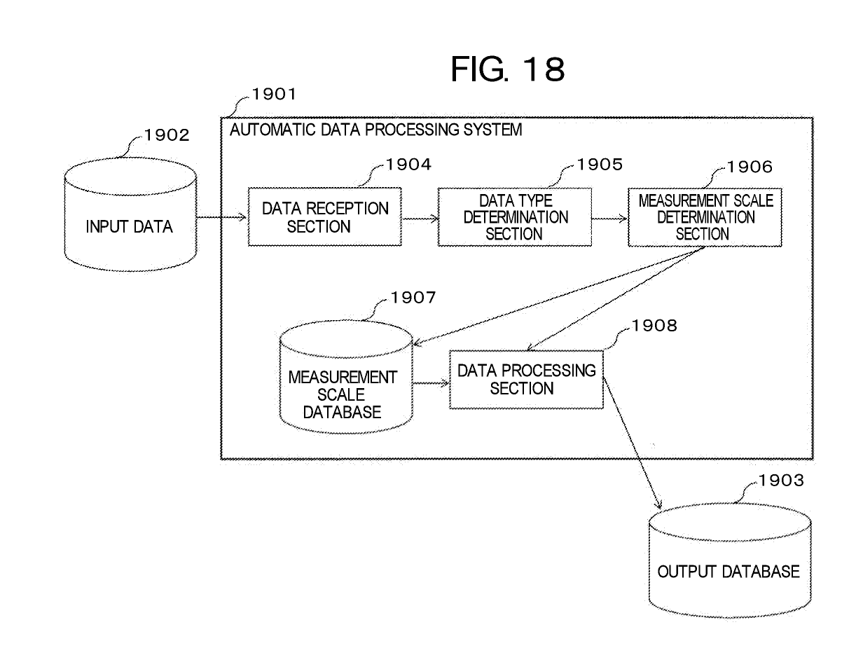

FIG. 18 illustrates an exemplary configuration of the automatic data processing system according to the first embodiment. The automatic data processing system 1901 receives input data 1902, determines the measurement scale of the data, processes the data, and outputs the processed data to an output database 1903. The automatic data processing system 1901 includes a data reception section 1904, a data type determination section 1905, a measurement scale determination section 1906, a measurement scale database 1907, and a data processing section 1908.

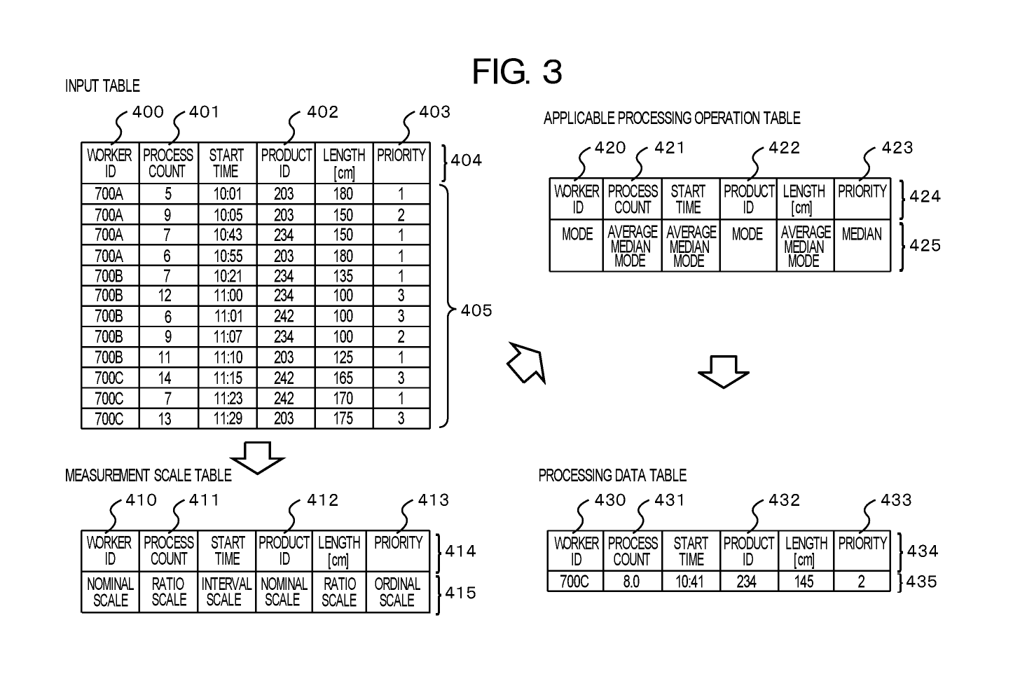

The data reception section 1904 receives the input data 1902. In such an instance, the received data may be converted into a data format handled in the automatic data processing system 1901. The input data 1902 is data on numbers, characters, and symbols. The input data 1902 is, for example, in a tabular form. An input table 400 that is shown in FIG. 3 and contains data in a tabular form is in an RDB (relational database) format. The input table 400 is formed of a key section 404 and a value section 405. Alternatively, the input table 400 may be formed of only the value section 402 and without the key section 404. For the sake of convenience, the input table 400 is in a tabular form. However, the input table 400 remains substantially unchanged even if it contains CSV (comma-separated value) data, space-separated data, or tab-separated data. The data reception section 1904 transmits the received data to the data type determination section 1905.

Upon receiving the data from the data reception section 1904, the data type determination section 1905 determines whether the data stored in each column is of a floating-point type, an integer type, or a character string type. For example, SQL, which is a typical database language, may be used for determination. If the result of determination is, for example, smallint, integer, or bigint, the data is determined to be of the integer type. If the result is, for example, decimal, numeric, or real, the data is determined to be of the floating-point type. If the result is other than the above, the data is determined to be of the character string type.

The data type determination section 1905 acquires information about the data type of data inputted to the automatic data processing system 1901 and each column of data, and transmits the acquired information to the measurement scale determination section 1906.

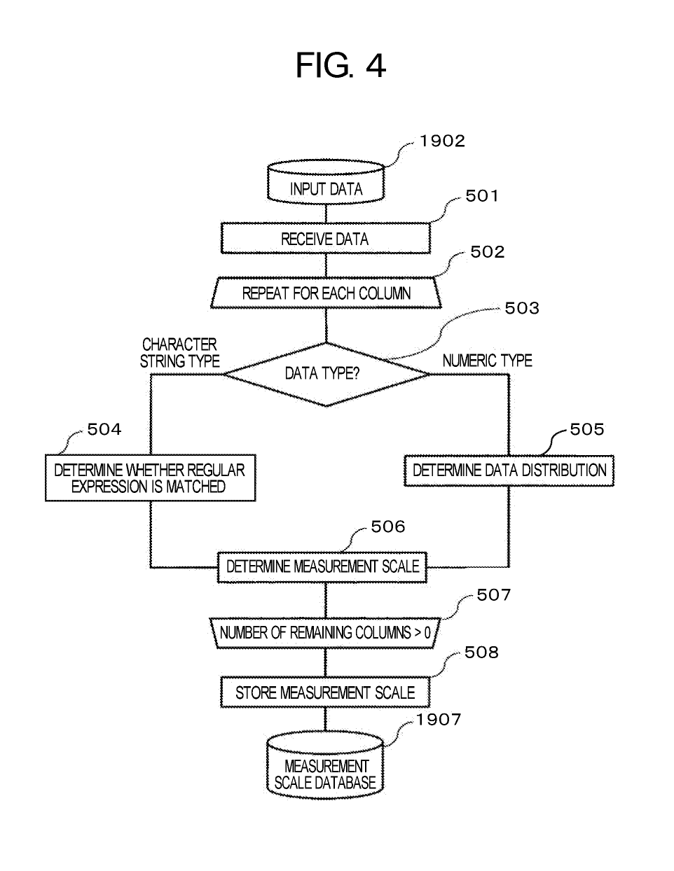

FIG. 4 is a flowchart illustrating an example of a process that is performed to receive the input data 1902 and store the measurement scale of each column in the measurement scale database 1907.

In step 501, the data reception section 1904 receives the input data 1902. Subsequently, steps 503, 504, 505, and 506 are repeated for each column of the input data 1902 (steps 502 and 507).

In step 503, the data type determination section 1905 determines the type of data in each column. The type of data in each column is determined by using, for example, the result of determination based on SQL, which is a typical database language as mentioned above. If the result of determination obtained in step 503 indicates that the data in a column is of the floating-point type or the integer type (hereinafter generically referred to as the numeric type), processing proceeds to step 505. If, by contrast, the result indicates that the data in a column is of the character string type, processing proceeds to step 504.

In step 504, a check is performed to determine whether a predetermined regular expression is matched. The predetermined regular expression is, for example, a date expression, a time expression, an interval expression, or a list expression.

In step 505, the distribution of data in a column is determined. The distribution of data denotes the statistical properties of data that are calculated based on statistical values of the data. The statistical properties of data are, for example, continuity, centrality, monotonic decrease, smoothness, and homoscedasticity.

In step 506, the measurement scale in each column is determined based on the match with the predetermined regular expression that is determined in step 504 or on the distribution of data that is determined in step 505.

Steps 504 to 506 are performed by the measurement scale determination section 1906. These processing steps are performed to determine whether each column is on a nominal scale, an ordinal scale, an interval scale, or a ratio scale.

In step 507, the measurement scale determined by the measurement scale determination section 1906 is linked to each column and stored in the measurement scale database 1907.

### <Description of Measurement Scales>

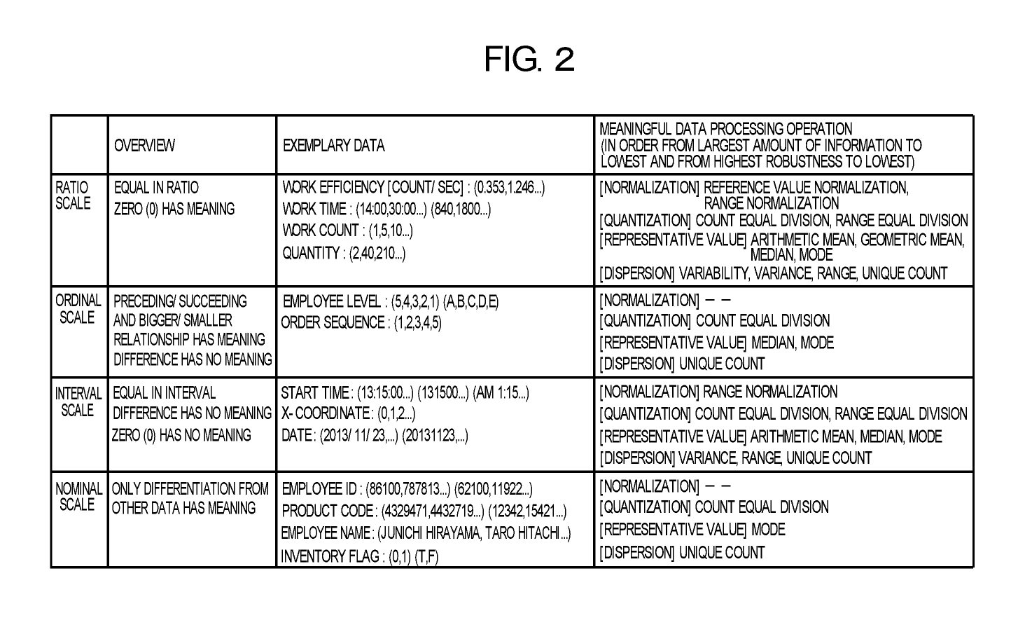

Examples of measurement scales will now be described with reference to FIG. 2.

The measurement scales are used in compliance with a standard that mathematically and statistically categorizes data stored in a column in accordance with the nature of information expressed by the data. Categories (Non-Patent Literature (NPL) 1) proposed by Stanley Stevens are often used. From the lowest to the highest, four different measurement scales are shown in FIG. 2. Higher measurement scales include the properties of lower measurement scales.

### Nominal Scale

Numbers and characters are regarded merely as names and assigned to individual data. If the same name is assigned to two pieces of data, they belong to the same category. A plurality of pieces of data can be compared to simply determine whether they are equal or different. They are neither arranged in a sequence nor subjectable to addition, subtraction, or other arithmetic operation. A representative value is expressed by a mode. For example, the data may be an ID, a name, or a flag. If the data includes work IDs, for example, of 00001, 00002, 00004, 00007, . . . , the data merely indicates that the work represented by a work ID of 00001 is different from the work represented by a work ID of 00002. The work IDs cannot be compared to determine which work is bigger.

### Ordinal Scale

Numbers and characters assigned to data indicate a sequence. A plurality of pieces of data can be compared to not only determine whether they are equal or different, but also determine which is preceding or succeeding and which is bigger or smaller. Meanwhile, the intervals between a sequenced set of data are not equal. Therefore, subjecting the data to addition, subtraction, or other arithmetic operation is meaningless. For example, if work efficiency values Gr. of 5, 4, 3, . . . are represented by the data, the data can be compared to determine that a work efficiency of 5 is higher than a work efficiency of 4. Meanwhile, the interval between a work efficiency of 5 and a work efficiency of 4 is not equal to the interval between a work efficiency of 4 and a work efficiency of 3. In this instance, therefore, the simple interval difference represented by a value of 1 is meaningless.

### Interval Scale

Numbers assigned to data satisfy all properties of the ordinal scale. Further, if the difference between a plurality of pieces of data is equal, it signifies that the intervals between them are equal. Comparing the difference between two pieces of data with the difference between another two pieces of data is meaningful. Addition and subtraction are also meaningful. However, the zero point on the interval scale may be arbitrarily represented by a negative value. A representative value is expressed, for example, by a mode, a median, or an arithmetic mean. The data represents, for example, a time and a date. If the data represents dates of November 4, November 6, November 8, . . . , the two-day difference between November 4 and November 6 has a quantitative meaning. Likewise, the two-day difference between November 4 and November 6 and the two-day difference between November 6 and November 8 can be compared to determine which is bigger.

### Ratio Scale

Numbers assigned to data satisfy all properties of the interval scale. Further, the ratio between two pieces of data is meaningful. Moreover, multiplication and division are meaningful. The zero point on the ratio scale is absolute. A representative value is expressed, for example, by a mode, a median, an arithmetic mean, or a geometric mean. The data represents, for example, a time and a quantity. If the data represents, for example, work quantities of 2, 5, 20, . . . , the ratio between 2 and 5 can be determined to signify that a work quantity of 5 is 2.5 times larger than a work quantity of 2.

The measurement scale determination section 1906 determines which of the above-described four measurement scales applies to each column that stores data. If the data type determination section 1905 determines that the data in a column is of the numeric type, the measurement scale determination section 1906 determines the distribution of the data. If, by contrast, the data in a column is determined to be of the character string type, the measurement scale determination section 1906 determines whether the regular expression is matched.

When the distribution of data is to be determined, the measurement scale determination section 1906 determines the distribution of the data stored in each column, and then determines the measurement scale of each column in accordance with the determined distribution of the data. The distribution of data may be calculated from the value of data and the frequency of the data value. Further, the distribution of data may be determined from the shape of a histogram that is created by indicating the value of data along the horizontal axis and the frequency of the data value along the vertical axis. Any combination other than the combination of the value of data and the frequency of the data value may be used for calculation as far as it determines the distribution of the data.

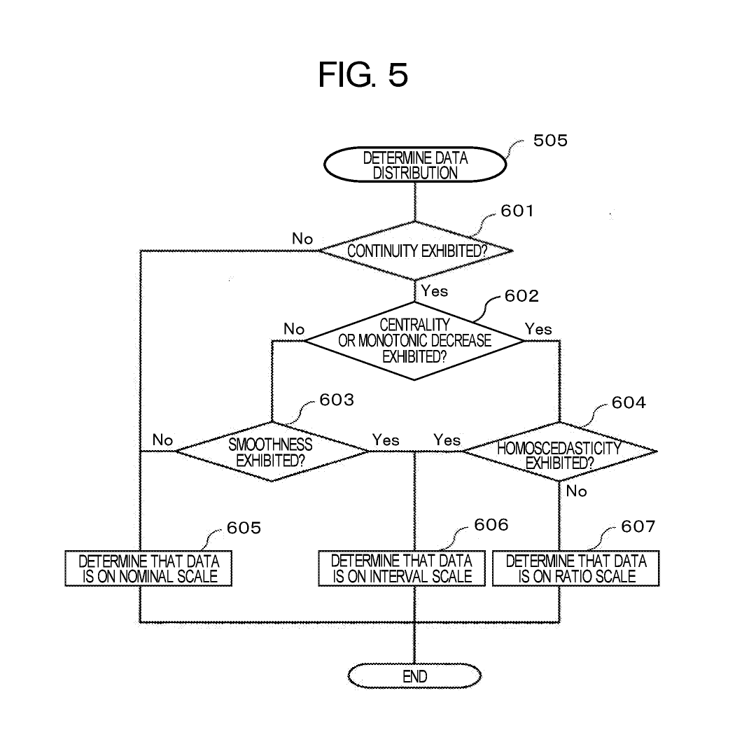

FIG. 5 is a flowchart illustrating an example of a process that is performed on numeric data for data distribution determination (step 505) and measurement scale determination (step 506) as shown in FIG. 4.

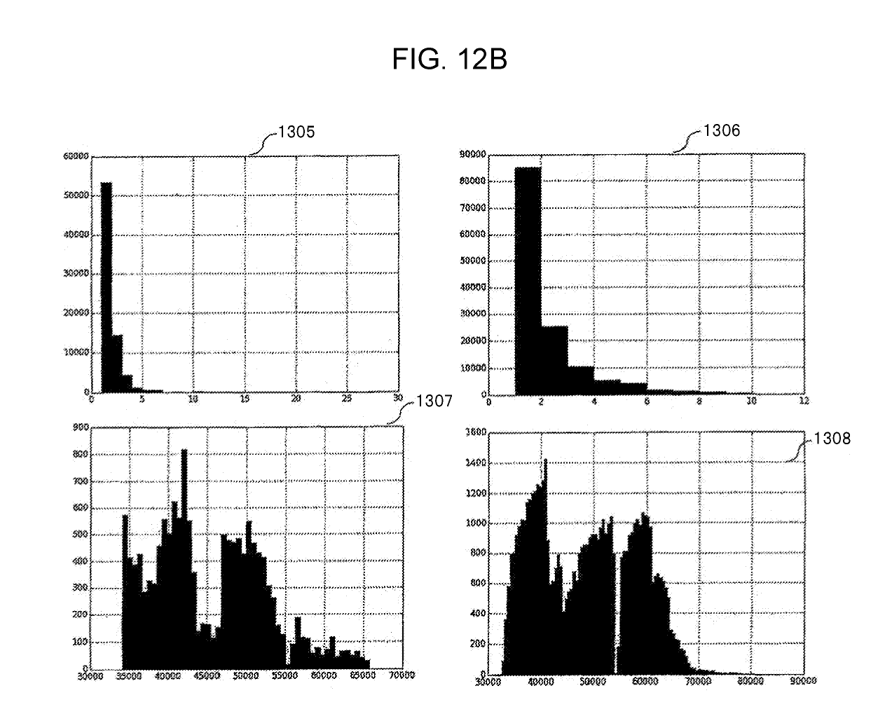

In step 601, a check is performed to determine whether data in a column exhibits sufficient continuity. The continuity is an index indicative of whether data in a column is uninterrupted and attached sufficiently close to each other. If numbers indicated by the data in the column are at equal intervals and have a quantitative meaning, that is, if the data is on the interval scale or on the ratio scale, the index is used to determine whether the data is unlikely to be irregularly interrupted. FIG. 12 is a set of diagrams illustrating various distributions of data. In FIG. 12, the horizontal axis represents the values of data, and the vertical axis represents the frequency of the data. In FIG. 12, histograms 1301 and 1302 represent a case where the data does not exhibit continuity, and the other histograms represent a case where the data exhibits continuity. For example, the following procedure may be performed to determine whether the data exhibits continuity:

(1) Sort the data in a column in ascending or descending order. Remove any duplicate value of the data.

(2) For all values in the data column mentioned in (1) above, determine the difference between two neighboring values.

(3) Determine the standard deviation of all the determined differences.

(4) If the determined standard deviation is equal to or smaller than a threshold value, it is determined that the data exhibits continuity.

It is preferable that the minimum difference be used to perform division after the differences are determined in (2) above. An alternative would be to determine whether the ratio between the standard deviation and range (maximum value-minimum value) of the data is not greater than a threshold value. A 75% point-25% point or a 90% point-10% point may be used instead of the range. Further, any method of calculating whether data values are continuous may be used. If it is determined in step 601 that the data exhibits continuity, processing proceeds to step 602. If, by contrast, it is not determined that the data exhibits continuity, it is determined that the data is on the nominal scale (step 605).

Performing step 601 determines a column having a gap between data values. As a result, it can be determined that the column is on the nominal scale. This makes it possible to determine whether numeric data is on the nominal scale or on a certain other measurement scale.

In step 602, it is determined whether the data in a column exhibits centrality or monotonic decrease. The centrality is an index indicative of whether a histogram is distributed in a mountainous form due to a large number of data existing at the center or average point of the data. In FIG. 12, histograms 1301 and 1304 represent a case where the data exhibits centrality, and the other histograms represent a case where the data does not exhibit centrality. The monotonic decrease is an index indicative of whether the vertical axis value gradually decreases with an increase in the horizontal axis value when a histogram is drawn. These indexes are used to identify a normal distribution shape, a log-normal distribution shape, and an exponential distribution shape, which are frequently found in a histogram of quantity data, particularly, a histogram of data on the ratio scale. In FIG. 12, histograms 1305 and 1306 represent a case where the data exhibits monotonic decrease, and the other histograms represent a case where the data does not exhibit monotonic decrease. Whether data exhibits centrality or monotonic decrease may be determined by checking whether kurtosis or skewness is not smaller than a threshold value. The kurtosis is a value calculated by Equation (1), and the skewness is a value calculated by Equation (2).

$$\begin{matrix}{\sum }_{i}^{N} {( {x}_{i} - μ )}^{4} / N {σ}^{4} & Equation ( 1 ) \\ {\sum }_{i}^{N} {( {x}_{i} - μ )}^{3} / N {σ}^{3} & Equation ( 2 )\end{matrix}$$

In Equations (1) and (2), xi (i=1 to N) is the value of each dat a, μ is an average, and σ is a standard deviation. Here, the kurtosis indicates the centrality of data. When the value of Equation (1) above is great, the kurtosis is high. It signifies that the data exhibits centrality. If, for example, the value of Equation (1) is 3 or greater, it may be determined that the data exhibits centrality. The skewness indicates the monotonic decrease of data. When the value of Equation (2) is great, the skewness is high. It signifies that the data exhibits monotonic decrease. If, for example, the value of Equation (2) is equal to or greater than 0.5, it may be determined that the data exhibits skewness. Any method may be used as far as it determines whether a histogram has a generally mountainous shape or exhibits monotonic decrease. If it is determined in step 602 that the data exhibits centrality or monotonic decrease, processing proceeds to step 604. If, by contrast, it is determined that the data does not exhibit centrality or monotonic decrease, processing proceeds to step 603.

Performing step 602 makes it possible to determine whether the data in a column exists irregularly.

In step 603, it is determined whether the data in a column exhibits smoothness. The smoothness is a value indicative of whether the vertical axis value gradually changes with an increasing horizontal axis value when a histogram is drawn. When a number indicated by the data in a column has a quantitative meaning, that is, the data is not on the nominal scale, the smoothness is an index for determining whether the frequency of data indicative of neighboring numbers is likely to increase. In FIG. 12, histograms 1304, 1307, and 1308 represent a case where the data exhibits smoothness, and the other histograms represent a case where the data does not exhibit smoothness. For example, the following procedure may be performed to determine whether the data exhibits smoothness:

(1) Note the maximum and minimum values of data in a column, and divide the range between the maximum and minimum values into some zones having equal width.

(2) Calculate the number of data in each zone.

(3) Calculate the difference between the number of data in a zone and the number of data in a neighboring zone. Perform this calculation on each zone.

(4) Calculate the average of the differences between all the calculated zones.

(5) If the calculated average is equal to or smaller than a threshold value, conclude that the data exhibits smoothness.

Any method may be used as far as it determines whether a histogram has a smooth shape. If it is determined in step 603 that the data exhibits smoothness, it is concluded that the data is on the interval scale. If, by contrast, it is determined in step 603 that the data does not exhibit smoothness, it is concluded that the data is on the nominal scale (steps 605 and 606).

Performing steps 602 and 603 makes it possible to determine a column where no gap exists between the values of data in the column and a significant frequency difference arises between data having neighboring values due to irregular data existence. As a result, it can be determined that the column is on the nominal scale. Further, it is possible to determine a column where no gap exists between the values of data in the column and data having neighboring values tend to exhibit similar frequency due to irregular data existence. As a result, it can be determined that the column is on the interval scale. This makes it possible to determine whether numeric data exhibiting no centrality or no monotonic decrease is on the nominal scale or on the interval scale.

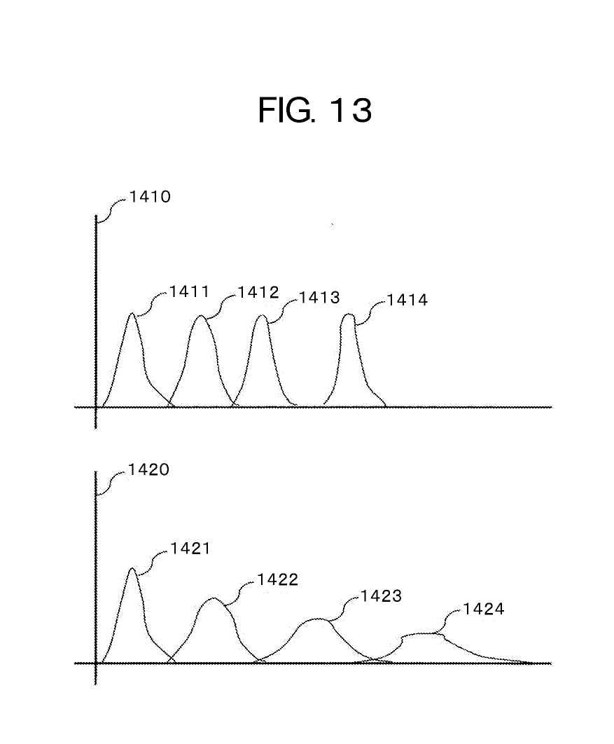

In step 604, it is determined whether the data in a column exhibits homoscedasticity. The homoscedasticity is an index indicative of whether a variance value varies with changes in the average value of data. FIG. 13 is a set of diagrams illustrating the distributions of data exhibiting homoscedasticity and data exhibiting no homoscedasticity. In FIG. 13, the upper histogram 1410 represents a case where the data exhibits homoscedasticity, and the lower histogram 1420 represents a case where the data does not exhibit homoscedasticity. The histogram 1410 shows that the variance of distribution remains unchanged even when the average value of distribution increases as indicated sequentially by distributions 1411, 1412, 1413, and 1414. Meanwhile, the histogram 1420 shows that the variance of distribution increases when the average value of distribution increases as indicated sequentially by distributions 1421, 1422, 1423, and 1424.

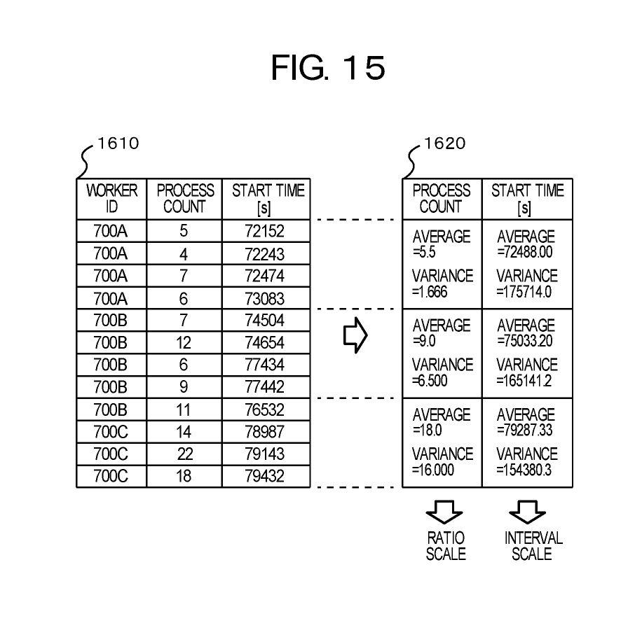

An exemplary procedure for determining whether data exhibits homoscedasticity is described below with reference to FIG. 15:

(1) Note the values in columns of interest (e.g., “PROCESS COUNT” and “START TIME [s]”) within the input table (1610) and determine the average and variance of the noted values in a row having the same process keys (e.g., “WORKER ID”) (within broken lines). The process key may be entered by a user or randomly selected by the automatic data processing system.

(2) Note the determined average and variance to determine whether the variance greatly changes with an increasing average. In the example of FIG. 15, the variance of “PROCESS COUNT” increases when the average increases, and the variance of “START TIME [s]” does not greatly change even when the average increases. The above determination may be made, for example, by calculating the variance/average of each process key and comparing the difference with a threshold value. When data exhibits homoscedasticity, the value of variance/average varies between each process key.

(3) If it is determined that the variance does not greatly change, conclude that the data exhibits homoscedasticity. If not, conclude that the data does not exhibit homoscedasticity.

If it is determined in step 604 that the data exhibits homoscedasticity, it is concluded that the data is on the interval scale, and if, by contrast, it is determined that the data does not exhibit homoscedasticity, it is concluded that the data is on the ratio scale (steps 606 and 607). The inventors of the present invention have newly found that the ratio scale and the interval scale can be identified in the above manner. Performing step 604 makes it possible to determine whether numeric data exhibiting continuity and centrality or monotonic decrease is on the interval scale or on the ratio scale.

After the measurement scale of each column is determined as described above, the measurement scale determination section 1906 stores, in the measurement scale database 1907, information obtained by linking the data stored in a column to a measurement scale. If, for example, the input table 400 shown in FIG. 3 is the input data 1902, the measurement scale of each column is stored in a value section 415 of a measurement scale table 410 in the measurement scale database. Further, the measurement scale determination section 1906 transmits a trigger for data processing to the data processing section 1908.

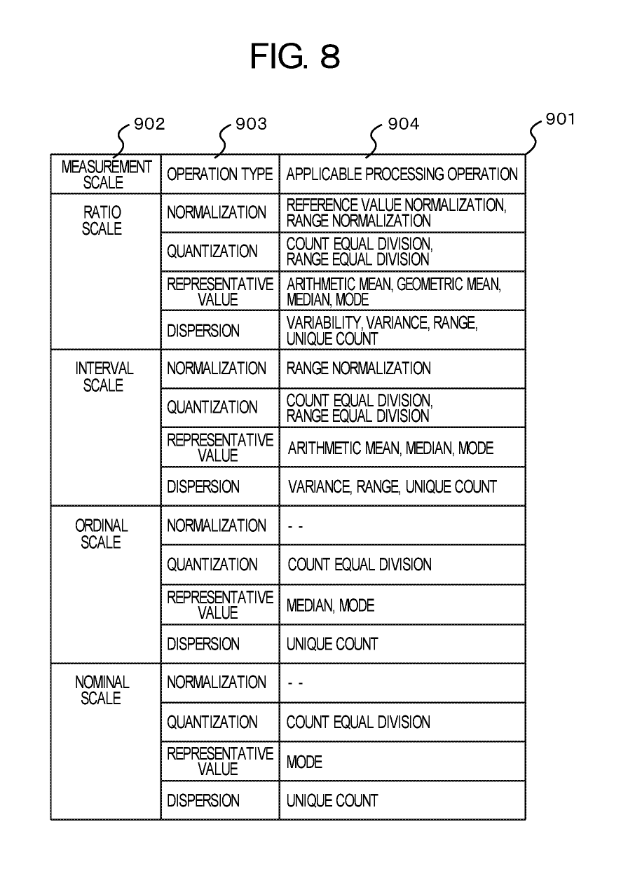

Upon receiving the trigger from the measurement scale determination section 1906, the data processing section 1908 processes the data in each column by performing an applicable arithmetic process on the data in accordance with the measurement scale of each column. FIG. 8 illustrates a table 901 storing processing operations that are applicable to each of the measurement scales 902 and operation types 903 and used by the data processing section 1908 to process individual data. The table 901 may be built in the data processing section 1908, or an applicable processing operation 904 may be read from the outside of the data processing section 1908 at the time of data processing. The data processing section 1908 reads the measurement scales in the measurement scale database 1907, performs an applicable processing operation 904 for each measurement scale on each column, and stores the result of data processing in the output database 1903. For example, data in each column is operated on and stored in a value section 435 of a processing data table 430 shown in FIG. 3. The processing data table 430 is built in the output database 1903.

The description given above assumes that each column is processed and that an output is delivered to a table. However, a column format and a table format need not always be used. Any format may be used as far as it defines a certain set of data. For example, data in a list format and not in a column format or an array of data may be processed.

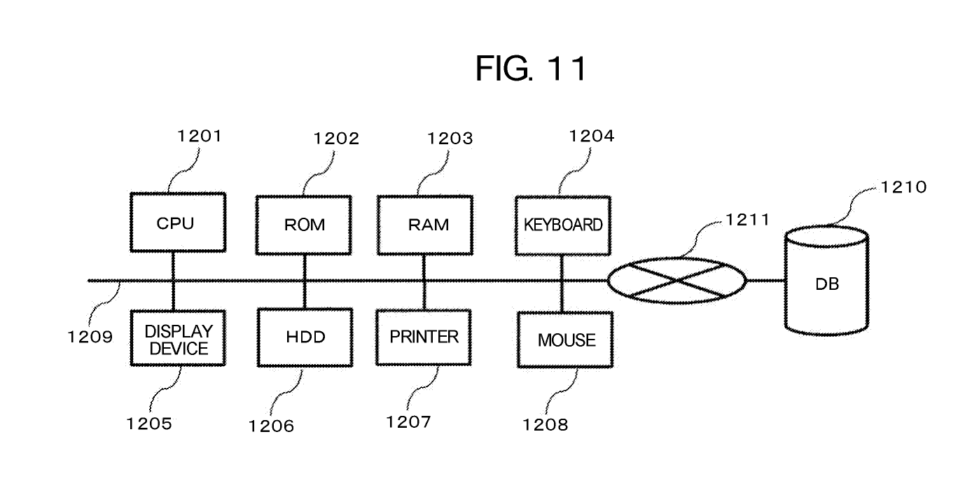

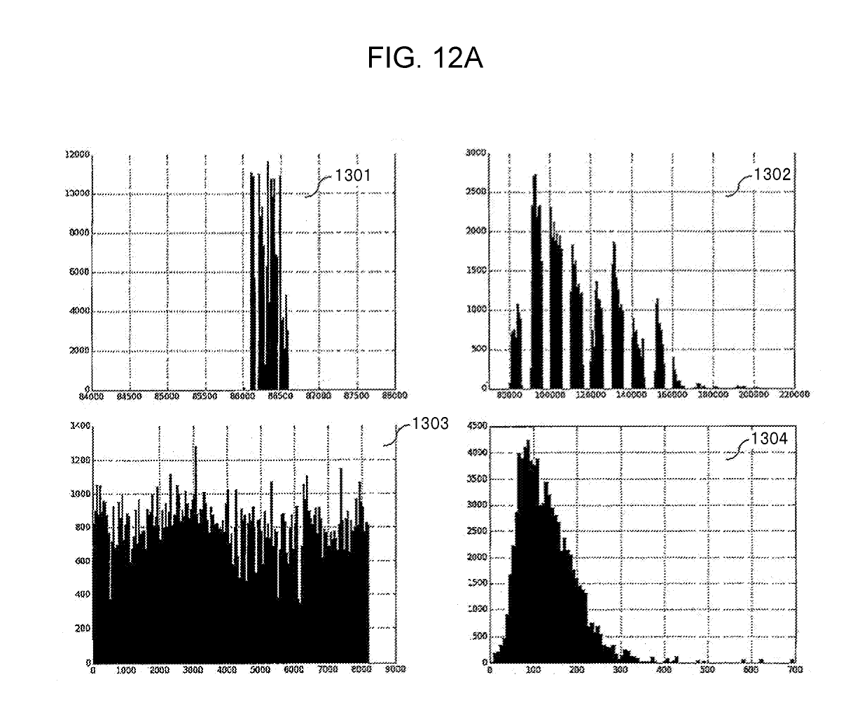

FIG. 11 is a diagram illustrating an exemplary hardware configuration for implementing the automatic data processing system according to the first embodiment.

In the first embodiment, the hardware configuration is implemented by using a computer system. The hardware configuration at least includes a CPU 1201, a ROM 1202, a RAM 1203, a keyboard 1204, a display device 1205, an HDD 1206, a printer 1207, a mouse 1208, a bus 1209, a DB 1210, and a network 1211.

The ROM 1202 stores, for example, an OS (operating system) of the automatic data processing system. The RAM 1203 stores computer software for automatic data processing. The keyboard 1204 is used to operate the CPU 1201. The HDD 1206 stores input data and processed data. The display device 1205 presents to the user the input data, the processed data, or the progress of data processing. The mouse 1208 is used to operate the CPU 1201. The bus 1209 is used to communicate various data. The DB 1210 stores various data. The network 1211 connects the bus 1209 to the DB 1210.

The automatic data processing system 1901 implements various functions shown in FIG. 18 by allowing the CPU 1201 to execute the computer software for automatic data processing, which is stored in the RAM.

As indicated above, the automatic data processing system 1901 according to the first embodiment includes the data reception section 1904, the data type determination section 1905, the measurement scale determination section 1906, and the data processing section 1908. The data reception section 1904 receives data on numbers, characters, and symbols. The data type determination section 1905 determines the type of the data. The measurement scale determination section 1906 determines the measurement scale of the data in accordance with the distribution of the data when the data is of the numeric type. The data processing section 1908 processes the data in accordance with the measurement scale.

Having the above-described configuration, the automatic data processing system 1901 according to the present embodiment is capable of automatically determining the measurement scale, which is an index for identifying the properties of data, and processing the data in a manner appropriate for the data.

<Exemplary Case where Data is of the Character String Type>

When the data type determination section 1905 determines that data in a column is of the character string type, the measurement scale determination section 1906 determines whether a regular expression is matched.

When determining whether a regular expression is matched, the measurement scale determination section 1906 determines whether data stored in each column matches a preselected regular expression, and determines the measurement scale depending on whether the preselected regular expression is matched.

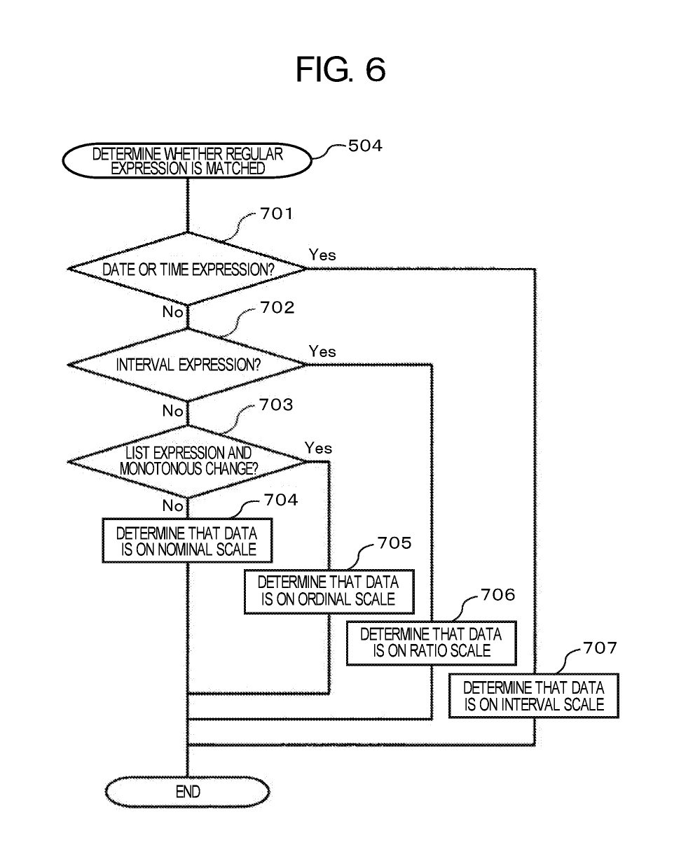

FIG. 6 is a flowchart illustrating an example of a process that is performed in a regular expression match determination step 504 and in a measurement scale determination step 506.

In step 701, it is determined whether data in a column is a date expression or a time expression. The date expression may be, for example, “2014/12/20”, “2014-12-20”, “14/12/20”, “14-12-12”, or “Dec. 20, 2014” (Dec. 20, 2014). The time expression may be, for example, “15:47” or “03:47 AM” (15:47) or “16:01:42” or “04:01:42” (16:01:42). Whether the data is a date expression or a time expression can be determined by writing the aforementioned exemplary expression in a regular expression and checking whether all character strings within the data stored in a column match the regular expression. As for a time expression, a regular expression needs to be written while paying attention to the range of possible time values in order to clarify the difference from a later-described interval expression. If the data corresponds to both a time expression and an interval expression, the earlier-described homoscedasticity determination method may be used to conclude that the data is a time expression if the data exhibits homoscedasticity and conclude that the data is an interval expression if the data does not exhibit homoscedasticity. If the data is of the character string type, homoscedasticity is determined after the data having a time expression or an interval expression is converted to numeric data. If, for example, the data is “12:30:00”, it is converted to “750” minutes. In this instance, conversion is performed in units of minutes. However, conversion may alternatively be performed in units of seconds or hours. Subsequently, time expression/interval expression determination is made by calculating the homoscedasticity distribution of the data from the value and frequency of the data. If it is determined in step 701 that the data is a date expression or a time expression, it is determined that the column is on the interval scale (step 707). If, by contrast, it is determined that the data is neither a date expression nor a time expression, processing proceeds to step 702. Performing step 701 makes it possible to determine whether a column storing character string type data is on the interval scale or on some other measurement scale.

In step 702, it is determined whether the data in the column is an interval expression. A character string having an interval expression may be, for example, “9′′ 58” (9 seconds 58), “3′ 26′′ 00” or “03:26” (3 minutes, 26 seconds, 00), or “2:02′ 57” or “02:02:57” (2 hours, 2 minutes, 57 seconds). Whether the data is an interval expression can be determined, for example, by writing the aforementioned exemplary expression in a regular expression and checking whether all character strings within the data stored in the column match the regular expression. If it is determined in step 702 that the data is an interval expression, it is determined that the column is on the ratio scale (step 706). If, by contrast, it is determined that the data is not an interval expression, processing proceeds to step 703. Performing step 702 makes it possible to determine whether a column storing data of the character string type is on the ratio scale or on some other measurement scale.

In step 703, it is determined whether the data in the column has a list expression and exhibits monotonic decrease. A character string having a list expression may be, for example, “1. * * * , 2. * * * , . . . ”, “1: * * *, 2: * * * , . . . ”, “A. * * * , B. * * * , . . . ”, or “I. * * *, II. * * * ”. Whether the data is a list expression can be determined, for example, by writing the aforementioned exemplary expression in a regular expression and checking whether all character strings within the data stored in the column match the regular expression.

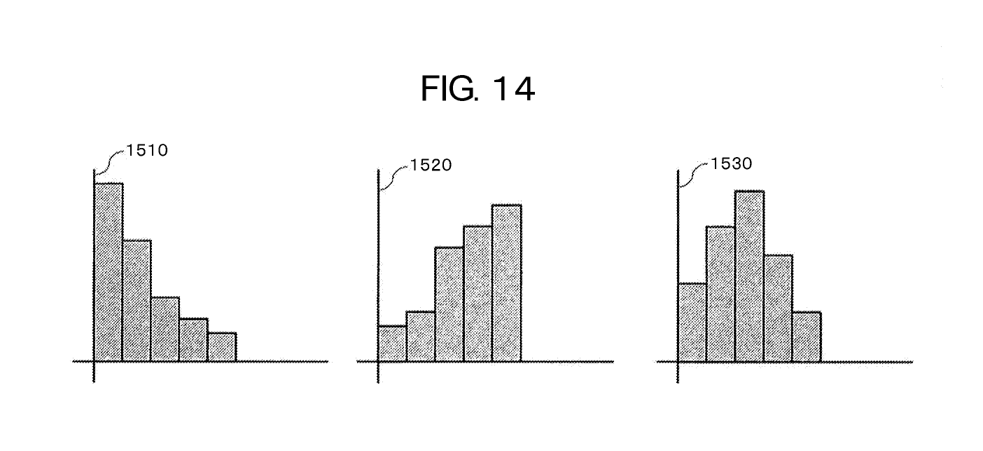

FIG. 14 is a set of diagrams illustrating the distributions of monotonously changing data.

Histograms shown in FIG. 14 are created by indicating the numeric value of each list (a character needs to be converted to a numeric value) along the horizontal axis and the frequency of the numeric value along the vertical axis.

A monotonous change occurs in one of three different cases. In a first case, a monotonic decrease occurs so that the value on the vertical axis gradually decreases in a regular manner as indicated by a histogram 1510. In a second case, a monotonic increase occurs so that the value on the vertical axis gradually increases in a regular manner as indicated by a histogram 1520. In a third case, there is only one peak with respect to a value increase on the horizontal axis as indicated by a histogram 1530 so that a monotonic increase occurs before the peak, and that a monotonic decrease occurs after the peak. If it is determined in step 703 that the data has a list expression and exhibits a monotonous change, it is determined that the column is on the ordinal scale, and if, by contrast, it is not determined that the data has a list expression and exhibits a monotonous change, it is determined that the column is on the nominal scale (steps 704 and 705). Performing step 703 makes it possible to determine whether data of the character string type is on the ordinal scale or on the nominal scale.

The above description assumes that the measurement scale is determined by sequentially performing steps 701 to 703. However, these steps may alternatively be performed in a different order. In such an instance, a column for which all queries in steps 701 to 703 are negatively answered is determined to be on the nominal scale.

As described above, the automatic data processing system 1901 includes the measurement scale determination section, which determines the measurement scale of character string type data depending on whether the data matches a predetermined regular expression. Such a configuration makes it possible to automatically determine the measurement scale, which is an index for determining the properties of data, even when the data is of the character string type, and process the data in a manner suitable for the data.

### <Exemplary Modification Concerning the Presentation of a Processing Operation>

An exemplary modification will now be described with reference to the presentation of a data processing operation appropriate for a determined measurement scale. The exemplary modification has basically the same system configuration as illustrated in FIG. 18, but differs in the following points.

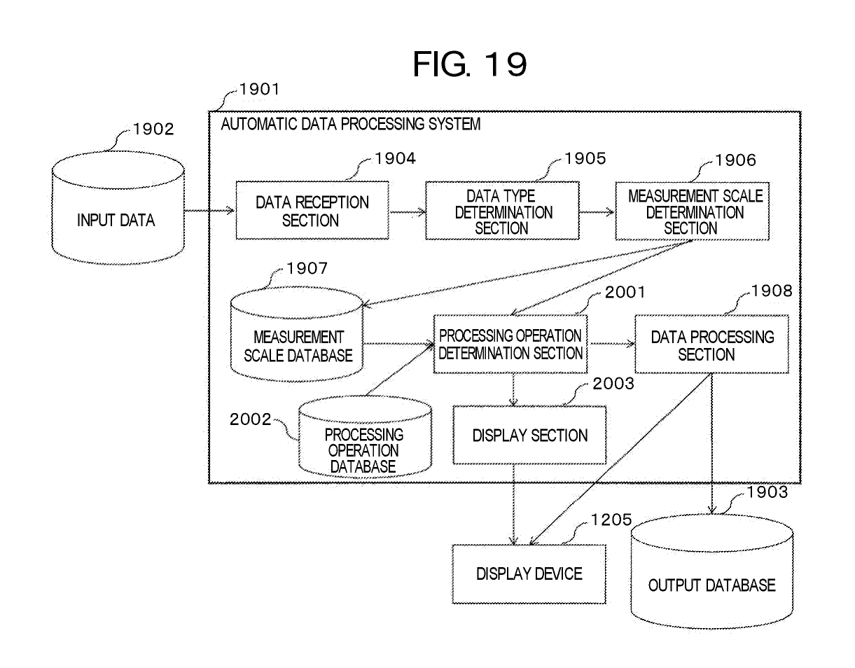

FIG. 19 is a diagram illustrating an automatic data processing system that presents a processing operation.

The automatic data processing system 1901 receives the input data 1902, determines the measurement scale of the data and a processing operation applicable to the data, displays the applicable processing operation on the display device 1205, and outputs processed data to the output database 1903. Further, the automatic data processing system 1901 may display the processed data on the display device.

In addition to the elements included in the configuration shown in FIG. 18, the automatic data processing system 1901 includes a processing operation determination section 2001, a processing operation database 2002, and a display section 2003.

The measurement scale determination section 1906 determines the measurement scale of each column, stores the determined measurement scale in the measurement scale database, and then transmits a trigger for a processing operation to the processing operation determination section 2001.

Upon receiving the trigger from the measurement scale determination section 1906, the processing operation determination section 2001 receives the measurement scale of each column from the measurement scale database 1907, receives a processing operation applicable to each measurement scale from the processing operation database 2002, selects a processing operation applicable to data in a target column in accordance with the measurement scale of each column, and transmits the selected processing operation to the display section 2003. Further, the processing operation determination section 2001 transmits to the data processing section 1908 a processing operation applicable to each column.

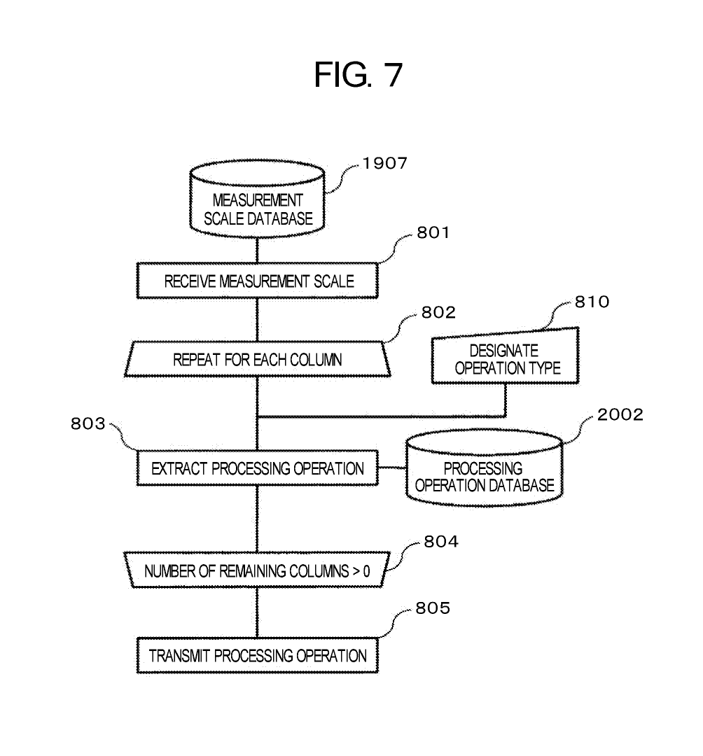

FIG. 7 is a flowchart illustrating a process performed by the processing operation determination section 2001.

In a measurement scale reception step 801, data inputted into each column and the measurement scale linked to each column are received from the measurement scale database 1907. The reception is performed so as to receive information indicative of the measurement scale of each column that is stored in the value section 415 of, for example, the measurement scale table shown in FIG. 3.

A processing operation extraction step 803, which is the next step, is repeated for each column in the table that is received in step 801 (steps 802 and 804). In the processing operation extraction step 803, an applicable operation is extracted from the processing operation database 2002 in accordance with a user-designated operation type and with the measurement scale received in the measurement scale reception step 801.

In an operation type designation step 810, the user designates the type of processing operation. The keyboard 1204 and the mouse 1208 can be used for designation. The designated processing operation type is received by a type reception section (not shown) in the automatic data processing system 1901. For example, normalization, quantization, representative value, or dispersion can be designated as the processing operation type. A display showing an operation type (selection) 1702 is an example of a user interface for type designation.

The processing operation database 2002 stores processing operations applicable to a column. The stored processing operations are classified by measurement scale and operation type. FIG. 8 is a diagram illustrating the table 901 that stores applicable processing operations 904 for each measurement scale 902 and operation type 903. The processing operation database 2002 may include, for example, the table 901 shown in FIG. 8.

In step 803, a processing operation applicable to data in each column is extracted based on data received in step 801 and inputted to each column and the measurement scale of each column, the operation type designated in step 810, and the applicable processing operations stored in the processing operation database 2002. If, for example, the measurement scale of a column is the nominal scale and the user-designated operation type is a representative value, the processing operation of a mode is extracted.

Operation types and applicable processing operations stored in the processing operation database 2002 are not limited to those indicated in FIG. 8. Operation types and applicable processing operations may be added or deleted as appropriate. Further, the table format shown, for example, at 901 need not always be used. Any other format may be used as far as applicable processing operations are linked to the measurement scales and each operation type.

In a processing operation transmission step 805, an applicable operation extracted by the processing operation determination section 2001 is transmitted to the display section 2003 and to the data processing section 1908. For example, an applicable processing operation table 420 shown in FIG. 3 may be used as a format for transmission.

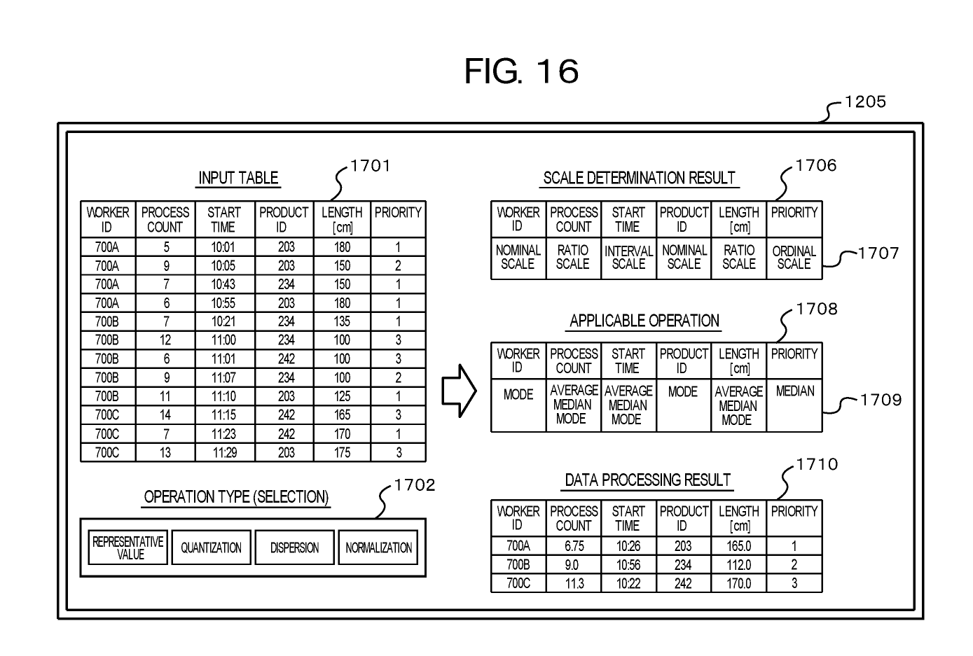

The display section 2003 transmits to the display device 1205 the processing operations applicable to each column that are received from the processing operation determination section 2001. The display device 1205 presents to the user the applicable processing operations received from the display section 2003. The received applicable processing operations are presented as shown at 1708 (APPLICABLE OPERATION) of FIG. 16. In this manner, a value section 1709 displays the processing operations applicable to each column.

The data processing section 1908 receives processing operations applicable to each column from the processing operation determination section 2001, and applies the processing operations applicable to each column. In such an instance, an applicable processing operation 904 associated with the user-designated operation type may be applied. Further, the data processing section 1908 may transmit to the display device 1205 the data to which a processing operation is applied, and allow the display device 1205 to present the data to the user. In such an instance, the data may be presented as shown at 1710 (DATA PROCESSING RESULT) of FIG. 16.

As described above, the automatic data processing system 1901 includes the processing operation determination section 2001, which links individual data on numbers, characters, and symbols to the measurement scales of the individual data, and determines processing operations applicable to the individual data, and the display section 2003, which displays the applicable processing operations on a screen.

The above-described configuration makes it possible to present processing operations that properly convert the data to a format providing machine learning and statistical analysis. Therefore, data processing operations can be performed even by a non-specialist having no knowledge of data mining and statistics. Further, even when a specialist handles an input data table having several hundred or more columns, performing manual setup in consideration of operations applicable to each column entails a significant cost. However, such a significant cost can be reduced. Moreover, it is possible to avoid useless analysis based on meaningless data processing and misunderstanding of analysis results.

### <Exemplary Modification Concerning the Selection of an Optimum Processing Operation>

Even if a certain data processing operation is applicable to data in a column, the result of such a data processing operation is inconsistent in some cases. Therefore, each time the result of data processing operation is obtained, analysis personnel need to check manually and intuitively whether the value of processed data is appropriate.

An exemplary modification will now be described with reference to the selection of an optimum processing operation from applicable processing operations. The exemplary modification has basically the same system configuration as illustrated in FIG. 19, but differs in the following points.

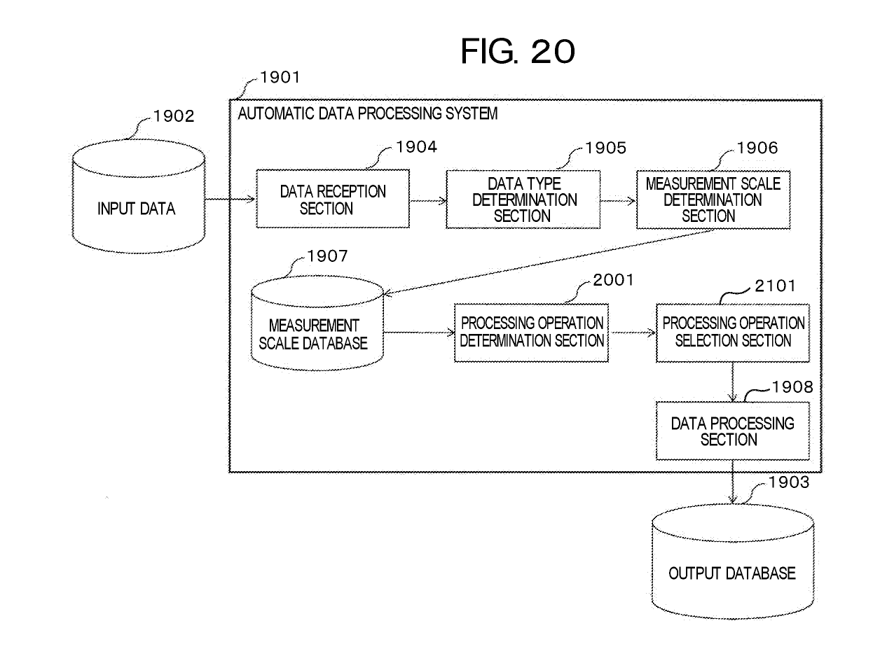

FIG. 20 is a diagram illustrating the automatic data processing system 1901 that selects an optimum processing operation.

The automatic data processing system 1901 receives the input data 1902, determines the measurement scale of a column, selects an optimum processing operation for each column, performs the optimum processing operation on the data, and outputs the processed data to the output database 1903.

In addition to the elements included in the configuration shown in FIG. 19, the automatic data processing system 1901 includes a processing operation selection section 2101.

The processing operation selection section 2101 selects an optimum processing operation applicable to each column from the applicable processing operations extracted by the processing operation determination section 2001, and then transmits the selected processing operation to the data processing section 1908.

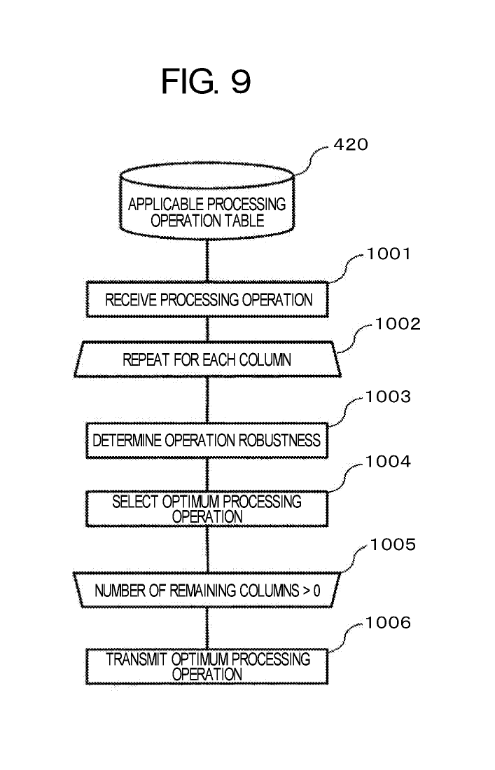

FIG. 9 is a flowchart illustrating a process performed by the processing operation selection section 2101.

In a processing operation reception step 1001, the processing operation selection section 2101 receives the applicable processing operation table 420 from the processing operation determination section 2001.

The next two steps, namely, an operation robustness determination step 1003 and an optimum processing operation selection step 1004, are repeated for each column in the applicable processing operation table 420 (steps 1002 and 1005).

The operation robustness determination step 1003 determines the robustness of applicable processing operations stored in a value section 425 of the applicable processing operation table 420.

The optimum processing operation selection step 1004 selects an optimum processing operation for each column in accordance with the value of robustness determined in the operation robustness determination step 1003.

Finally, an optimum processing operation transmission step 1006 is performed to transmit to the data processing section 1908 a processing operation optimum for each column, which is selected in the optimum processing operation selection step 1004 by the processing operation selection section 2101.

The data processing section 1908 performs the received processing operation optimum for each column on individual data in a column.

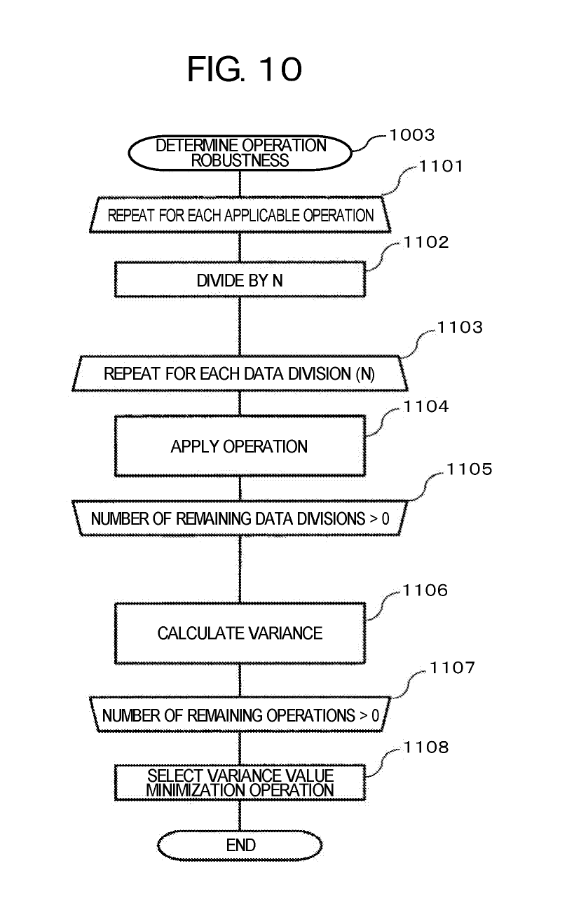

The sequence of a process performed in the operation robustness determination step 1003 and optimum processing operation selection step 1004 will now be described with reference to FIG. 10.

A divide-by-N step 1102, an operation application step 1104, and a variance calculation step 1106 are repeated for each applicable processing operation stored in each value section of the applicable processing operation table.

First of all, in the divide-by-N step 1102, data is randomly divided into N sets. N may be designated by the user or an arbitrary value. The data may be divided, for example, into 5 to 10 sets.

Next, the operation application step 1104 is repeated for each of the N divided sets of data.

The operation application step 1104 performs the applicable processing operation, which is received in the processing operation reception step 1001, on the divided sets of data, and then calculates the value of the processed data.

The variance calculation step 1106 calculates the variance of the values of the N sets of processed data. The variance may be calculated in a conventional manner.

Finally, a variance value minimization operation selection step 1108 regards a processing operation for minimizing the variance value calculated in the variance calculation step 1106 as the most robust operation, and selects the most robust operation as the optimum processing operation. Here, operation robustness is a property indicating how small the variability of individual data values operated on is.

The above assumes that operation robustness is determined based on variance. However, operation robustness can be similarly determined based on standard deviation.

The foregoing description assumes that processing is performed on each column and that the result of processing is outputted in the form of a table. However, the output need not always be generated in a column format or in a table format. Any format may be used as far as it defines a certain set of data. For example, processing need not always be performed on a column format, but may be performed on a list of data or on an array of data.

As described above, the automatic data processing system 1901 includes the processing operation determination section 2001, which determines a processing operation that is linkable to the measurement scale of individual data on numbers, characters, and symbols and applicable to the individual data, the processing operation selection section 2101, which selects a processing operation for minimizing the variability of values of the individual data operated on, and the data processing section 1908, which processes the data by applying a processing operation that minimizes the variability of the values of individual data.

When a plurality of applicable data processing operations are available, the above-described configuration makes it possible to process data by performing an operation that most stabilizes the values operated on.

This increases the accuracy of data analysis. Further, highly accurate data analysis can be made without processing data on a trial and error basis.

### Second Embodiment

A second embodiment of the automatic data processing system according to the present invention will now be described.

The second embodiment relates to a GUI (graphical user interface) for the automatic data processing system. The automatic data processing system according to the second embodiment has the same basic configuration as illustrated in FIGS. 19 and 20.

As illustrated in FIG. 16, the display device 1204 displays a GUI for permitting the user to perform a data processing procedure. Whenever an input is made by the user, the display device 1204 displays a new data processing result in accordance with the input from the user. The input from the user is made through the keyboard 1203 and the mouse 1206, which are shown in FIG. 11.

First of all, when the user enters the input table 400 shown in FIG. 3 into the automatic data processing system, the input table 400 appears in an input table display section 1701.

An operation type selection section 1702 allows the user to select one of the operation types previously defined in an applicable processing operation storage table 901 shown in FIG. 8. The operation type selected by the user is inputted to the operation type designation step 810 shown in FIG. 7.

When the measurement scale determination section 1906 determines the measurement scale of each column in the input table 400, a measurement scale determination result display section 1706 displays the measurement scale table 410 shown in FIG. 3. A measurement scale selection section 1707 sets, by default, the measurement scale that is automatically determined by the measurement scale determination section 1906. However, the user can perform a rewrite as needed to reset the measurement scale.

When the operation type selection section 1702 and the measurement scale selection section 1707 select an operation type and a measurement scale, respectively, the processing operation determination section 2001 prepares the applicable processing operation table 420 shown in FIG.

3, and causes an applicable operation display section 1708 to display the prepared applicable processing operation table 420. As the applicable operations for each column, the processing operation selection section 2101 may display only the selected most robust processing operation or display processing operations in order from the most robust to the least robust.

When a plurality of applicable operations are available, an applicable operation selection section 1709 permits the user to select one of the available applicable operations.

When an operation is selected in the applicable operation selection section 1709, a data processing result display section 1710 displays the processing data table 430 shown in FIG. 3.

The above-described configuration makes it possible to perform data processing while automatically determining the measurement scale of each column and presenting applicable operations to the user. Therefore, even a non-specialist having no knowledge of data analysis can easily perform data analysis while understanding the properties of data.

### Third Embodiment

A third embodiment will now be described. The third embodiment relates to an automatic data analysis system that uses the automatic data processing system according to the present invention.

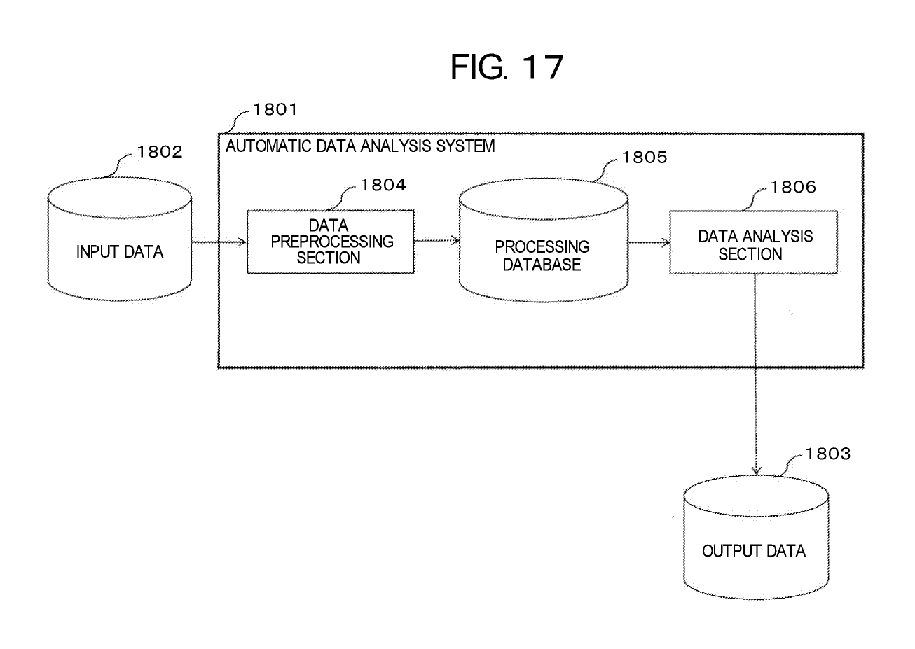

FIG. 17 is a diagram illustrating a configuration of the automatic data analysis system according to the third embodiment. The automatic data analysis system 1801 receives input data 1802, which is big data acquired, for example, by a sensor, analyzes the data, and outputs output data 1803. The automatic data analysis system 1801 includes a data preprocessing section 1804, a processing database 1805, and a data analysis section 1806.

The data preprocessing section 1804 receives the input data 1802, processes the received data as needed to obtain data suitable for data analysis, and stores the processed data in the processing database 1805. The data preprocessing section 1804 includes the automatic data processing system described in conjunction with the first embodiment, determines the measurement scale of each column of input data, and processes the data by performing an applicable operation on each column.

The data analysis section 1806 performs correlation analysis, regression analysis, or clustering or other well-known machine learning and statistical analysis on data stored in the processing database 1805. The result of analysis is then outputted as the output data 1803 from an output section (not shown).

The hardware configuration for implementing the automatic data analysis system 1801 is the same as for the first embodiment, which is shown in FIG. 11.

As mentioned above, the automatic data analysis system 1801 according to the third embodiment includes the data reception section 1904, the data type determination section 1905, the measurement scale determination section 1906, the data processing section 1908, the data analysis section 1806, and the output section. The data reception section 1904 receives data on numbers, characters, and symbols. The data type determination section 1905 determines the type of data. The measurement scale determination section 1906 determines the measurement scale of data in accordance with the distribution of the data when the data is of the numeric type. The data processing section 1908 processes data in accordance with a measurement scale. The data analysis section 1806 analyzes the data processed by the data processing section. The output section outputs the data analyzed by the data analysis section. The above-described configuration reduces the data preprocessing load on the user and makes it easy for the automatic data analysis system to perform preprocessing.

### REFERENCE SIGNS LIST

100 . . . input table,

101 . . . worker ID,

102 . . . process count,

103 . . . product ID,

104 . . . work ID,

111 . . . worker ID,

112 . . . process count,

113 . . . product ID,

400 . . . input table,

401 . . . process count,

402 . . . product ID,

403 . . . priority,

404 . . . key section,

405 . . . value section,

410 . . . measurement scale table,

411 . . . process count,

412 . . . product ID,

413 . . . priority,

414 . . . key section,

415 . . . value section,

420 . . . applicable processing operation table,

421 . . . process count,

422 . . . product ID,

423 . . . priority,

424 . . . key section,

425 . . . value section,

430 . . . processing data table,

431 . . . process count,

432 . . . product ID,

433 . . . priority,

434 . . . key section,

435 . . . value section,

501 . . . data reception step,

502, 507 . . . repeat for each column,

503 . . . data type determination step,

504 . . . regular expression match determination step,

505 . . . data distribution determination step,

506 . . . measurement scale determination step,

508 . . . measurement scale storage step,

601 . . . continuity determination step,

602 . . . centrality and monotonic decrease determination step,

603 . . . smoothness determination step,

604 . . . homoscedasticity determination step,

605 . . . nominal scale determination,

606 . . . interval scale determination,

607 . . . ratio scale determination,

701 . . . date expression and time expression determination step,

702 . . . time expression determination step,

703 . . . list expression and monotonous change determination step,

704 . . . nominal scale determination,

705 . . . ordinal scale determination,

706 . . . ratio scale determination,

707 . . . interval scale determination,

801 . . . measurement scale reception step,

802, 804 . . . repeat for each column,

803 . . . processing operation extraction step,

805 . . . processing operation transmission step,

810 . . . operation type designation step,

901 . . . applicable processing operation storage table,

902 . . . measurement scale,

903 . . . operation type,

904 . . . applicable processing operation,

1001 . . . processing operation reception step,

1002, 1005 . . . repeat for each column,

1003 . . . operation robustness determination step,

1004 . . . optimum processing operation selection step,

1006 . . . optimum processing operation transmission step,

1101, 1107 . . . repeat for each applicable operation,

1102 . . . Divide-by-N step,

1103, 1105 . . . repeat for each divided data,

1104 . . . operation application step,

1106 . . . variance calculation step,

1108 . . . variance value minimization operation selection step,

1201 . . . CPU,

1202 . . . ROM,

1203 . . . RAM,

1204 . . . keyboard,

1205 . . . display device,

1206 . . . HDD,

1207 . . . printer,

1208 . . . mouse,

1209 . . . bus,

1210 . . . DB,

1211 . . . network,

1301 to 1303 . . . exemplary histogram indicative of data distribution having nominal scale,

1304 to 1306 . . . exemplary histogram indicative of data distribution having ratio scale,

1307, 1308 . . . exemplary histogram indicative of data distribution having interval scale,

1410 . . . exemplary histogram indicative of data distribution exhibiting homoscedasticity,

1420 . . . exemplary histogram indicative of data distribution exhibiting no homoscedasticity,

1510, 1520, 1530 . . . exemplary histogram indicative of data distribution exhibiting monotonous change,

1610 . . . input table,

1620 . . . table obtained after average and variance determination,

1701 . . . input table display section,

1702 . . . operation type selection section,

1706 . . . measurement scale determination result display section,

1707 . . . measurement scale selection section,

1708 . . . applicable operation display section,

1709 . . . applicable operation selection section,

1710 . . . data processing result display section,

1801 . . . automatic data analysis system,

1802 . . . input data,

1803 . . . output data,

1804 . . . data preprocessing section,

1805 . . . processing database,

1806 . . . data analysis section,

1901 . . . automatic data processing system,

1902 . . . input data,

1903 . . . output database,

1904 . . . data reception section,

1905 . . . data type determination section,

1906 . . . measurement scale determination section,

1907 . . . measurement scale database,

1908 . . . data processing section,

2001 . . . processing operation determination section,

2002 . . . processing operation database,

2003 . . . display section,

2101 . . . processing operation selection section.

1. An automatic data processing system comprising:
a reception section that receives data on numbers, characters, and symbols;
a data type determination section that determines the type of the data;
a measurement scale determination section that determines the measurement scale of the data in accordance with the distribution of the data when the data is of a numeric type; and
a data processing section that processes the data in accordance with the determined measurement scale.

2. The automatic data processing system according to claim 1, wherein the distribution of the data is the frequency distribution of data that is based on the value of the data and on the frequency of the value of the data.

3. The automatic data processing system according to claim 2, wherein the measurement scale determination section determines the measurement scale of the data in accordance with the shape of a histogram indicative of the value of the data and the frequency of the value of the data.

4. The automatic data processing system according to claim 2, wherein the measurement scale determination section determines whether the frequency distribution of the data exhibits continuity; and wherein, if the frequency distribution of the data is determined as exhibiting no continuity, the measurement scale determination section determines that the data is on a nominal scale.

5. The automatic data processing system according to claim 2, wherein the measurement scale determination section determines whether the frequency distribution of the data exhibits continuity, centrality, monotonic decrease, and homoscedasticity; and wherein, if the frequency distribution of the data exhibits continuity, exhibits centrality or monotonic decrease, and does not exhibit homoscedasticity, the measurement scale determination section determines that the data is on a ratio scale.

6. The automatic data processing system according to claim 1, wherein, if the data is of a character string type, the measurement scale determination section determines the measurement scale of the data depending on whether the data matches a predetermined regular expression.

7. The automatic data processing system according to claim 6, wherein, if the data matches the regular expression of a list expression and the frequency distribution of data based on the value of the data and on the frequency of the value of the data exhibits a monotonous change, the measurement scale determination section determines that the data is on an ordinal scale.

8. The automatic data processing system according to claim 6, wherein, if the data matches the regular expression of a time expression and the regular expression of an interval expression, the measurement scale determination section determines that the data is a time expression in a case where the frequency distribution of data based on the value of the data and on the frequency of the value of the data is determined as exhibiting homoscedasticity, and determines that the data is an interval expression in a case where the frequency distribution of data based on the value of the data and on the frequency of the value of the data is determined as exhibiting no homoscedasticity, and then determines the measurement scale of the data.

9. The automatic data processing system according to claim 1, further comprising:
a processing operation determination section that determines a processing operation that is linked to the measurement scale of each data on numbers, characters, and symbols and applicable to the each data; and
a display section that displays the applicable processing operation on a screen.

10. The automatic data processing system according to claim 1, further comprising:
a processing operation determination section that determines processing operations that are linked to the measurement scale of each data on numbers, characters, and symbols and applicable to the each data; and
an optimum processing operation selection section that selects, from among the applicable processing operations, a processing operation that minimizes the variation of the value of the each data operated on;
wherein the data processing section processes the data by applying the processing operation that minimizes the variation of the value of the each data.

11. An automatic data processing method that inputs data on numbers, characters, and symbols, the automatic data processing method comprising:
a reception step of receiving the data;
a data type determination step of determining the type of the data;
a measurement scale determination step of determining the measurement scale of the data in accordance with the distribution of the data when the data is of the numeric type; and
a data processing step of processing the data in accordance with the determined measurement scale.

12. The automatic data processing method according to claim 11, wherein the distribution of the data is the frequency distribution of data that is based on the value of the data and on the frequency of the value of the data.

13. An automatic data analysis system comprising:
a reception section that receives data on numbers, characters, and symbols;
a data type determination section that determines the type of the data;
a measurement scale determination section that determines the measurement scale of the data in accordance with the distribution of the data when the data is of the numeric type;
a data processing section that processes the data in accordance with the determined measurement scale;
a data analysis section that analyzes data processed by the data processing section; and
an output section that outputs data analyzed by the data analysis section.

14. The automatic data analysis system according to claim 13, wherein the distribution of the data is the frequency distribution of data that is based on the value of the data and on the frequency of the value of the data.
